(19) United States
(12) Patent Application Publication
(10) Pub. No.: US 2012/0103235 A1
(43) Pub. Date: May 3, 2012

(54) MODULAR CONFERENCE TABLE

(75) Inventor: AARON SUMMERVILLE, CANAL FULTON, OH (US)

(73) Assignee: REGENCY SEATING, INC., AKRON, OH (US)

(21) Appl. No.: 13/346,779

(22) Filed: Jan. 10, 2012

Related U.S. Application Data
(60) Provisional application No. 61/471,404, filed on Apr. 4, 2011.

(51) Int. Cl. A47B 1/04; B23P 11/00; A47B 13/08

(52) U.S. Cl. 108/89; 108/60; 29/428

(57) ABSTRACT

A modular conference table allows meeting participants and office staff to quickly and effectively change the length of the conference table as the needs of the meeting participants change. The present invention includes a tabletop assembly including a first end-top, a second end-top, and a modular insert top. Additionally, modular conference table includes a leg assembly upholding the tabletop assembly. The legs assembly includes two terminal supports and center supports. The modular conference table can be expanded in order to accommodate the needs of the user by adding an additional number of modular insert tops, modesty panels, and center supports. Thus, the invention allows attendees of meetings and office staff to adjust the size of a conference table according to the size of the space or the needs of the user.

This application claims priority to a provisional patent application Ser. No. 61/471,404, filed Apr. 4, 2011, which is hereby incorporated by reference. This invention generally relates to methods and apparatuses concerning conference tables and more specifically relates to methods and apparatuses concerning a modular conference table which is expandable and retractable according to the space available.

### BACKGROUND

A. Field of Invention

B. Description of the Related Art

It is long known in the art to provide conference tables for group meeting rooms. Manufacturers of conference tables must manufacture different sized tabletops of different lengths to suit the needs of consumers. For example, a manufacturer must manufacture a shorter tabletop for those buyers with a small amount of space in which to accommodate a conference table. Conversely, a manufacturer must manufacture a longer tabletop for those buyers with a larger amount of space in which to accommodate a conference table. However, furniture making and building techniques must advance to efficiently handle differing consumer needs and space availability.

Further, if the number of persons using a conference table changes, the consumer may desire to increase or decrease the size of the conference table. This means that the furniture manufacturers must do more than simply provide a conference table, but must provide a conference table that is expandable and retractable in a user-friendly way. It is still desirable, however, to provide an easy way for meeting participants and office staff to quickly and effectively change the length of the conference table as the needs of the meeting participants change. This will allow attendees of the meetings to adjust the size of a conference table according to the size of the space or the needs of the user.

What is needed, then, is a modular conference table that allows for the easy adjustment of the length of the conference table according to consumer needs and the amount of space available. As a result, the length of the conference table may be adjusted by the addition or removal of inserts which comprise the conference tabletop and by the addition and removal of the center supports.

### II. SUMMARY

According to one embodiment, a modular conference table includes (1) a tabletop assembly including (a) a first end-top, (b) a second end-top and (c) a modular insert top which includes at least one elongated central opening in which a grommet is placed where the modular insert top is interposed between the first and second end-tops to form a singular elongated work surface, (2) a leg assembly upholding the tabletop assembly where the leg assembly includes (a) a first terminal support perpendicularly attached to the first end-top, (b) a second terminal support perpendicularly attached to the second end-top and (c) a center support located between the terminal supports and perpendicularly attached to the modular insert top, and (3) two modesty panels (a) wherein the first modesty panel is interposed between the first terminal support and the center support (b) wherein the second modesty panel is interposed between the second terminal support and the center support and (c) where each modesty panel is perpendicularly attached to the elongated work surface.

According to another embodiment, a modular conference table includes (1) a tabletop assembly including (a) a first end-top, (b) a second end-top and (c) at least two modular insert tops which are aligned with one another to form an inner tabletop assembly where the inner tabletop assembly formed by the modular insert tops is interposed between the first and second end-tops to form an elongated work surface, (2) a leg assembly upholding the tabletop assembly where the leg assembly includes (a) a first terminal support perpendicularly attached to the first end-top, (b) a second terminal support perpendicularly attached to the second end-top and (c) at least two center supports located between the terminal supports and perpendicularly attached to each modular insert top, and (3) at least three modesty panels where each modesty panel is perpendicularly attached to the elongated work surface and (a) where the at least three modesty panels are perpendicularly attached to the elongated work surface and (b) where the at least three modesty panels are also located between the first and second terminal supports.

According to yet another embodiment, a method may comprise the steps of: (A) inserting cam pins, dowel rods, and double cam pins into existing holes in a first and a second terminal support, a first and a second end-top, a first and a second modular insert top, and an alpha, a beta, and a gamma modesty panel; (B) attaching the first and second modular insert tops to one another such that each modular insert top is abutted end-to-end with the other and is aligned to form an inner tabletop assembly and tightening the associated cam locks: (C) attaching the first and second end-tops to opposite ends of the inner tabletop assembly such that the inner table assembly and the first and second end-tops are abutted end-to-end with one another and are aligned to form an elongated work surface; (D) attaching the first center support to the first modular insert top and tightening the associated cam locks; (E) attaching the beta modesty panel to the first center support and the first and second insert tops and tightening the associated cam locks; (F) attaching the second center support to the second insert top and tightening the associated cam locks; (G) attaching the gamma modesty panel to the second center support, the second insert top, the second end-top and tightening the associated cam locks; (H) attaching the second terminal support to the second end-top and the gamma modesty panel and tightening the associated cam locks; (I) attaching the alpha modesty panel to the first center support, the first insert top, and the first end-top and tightening the associated cam locks; (J) attaching the first terminal support to the first end-top and the alpha modesty panel and tightening the associated cam locks.

Many benefits and advantages will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of the modular conference table;

FIG. 2 is perspective view underneath the modular conference table;

FIG. 3 is an exploded view of the modular conference table;

FIG. 4 is a front view of the hardware;

FIG. 5 is an exploded view of the modular conference table;

FIG. 6 is an exploded view of the elongated work surface;

FIG. 7 is a detailed view of the modular conference table;

FIG. 8 is a front perspective view of the support assembly;

FIG. 9 is a detailed view of the support assembly;

FIG. 10 is a perspective view of the modular conference table;

FIG. 11 is a side view of the modular conference table;

FIG. 12 is a side view of the modular conference table;

FIG. 13 is a side view of the modular conference table;

FIG. 14 is a side view of the modular conference table; and,

FIG. 15 is an exploded view of the underside of the modular conference table.

### IV. DETAILED DESCRIPTION

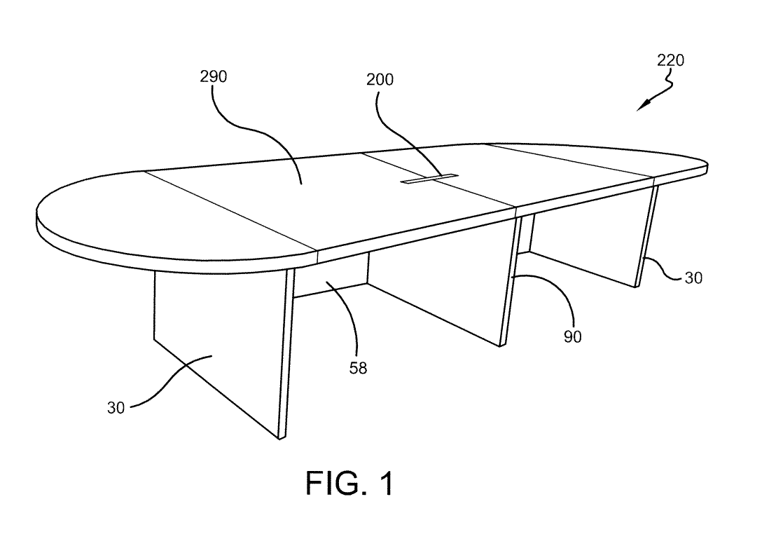

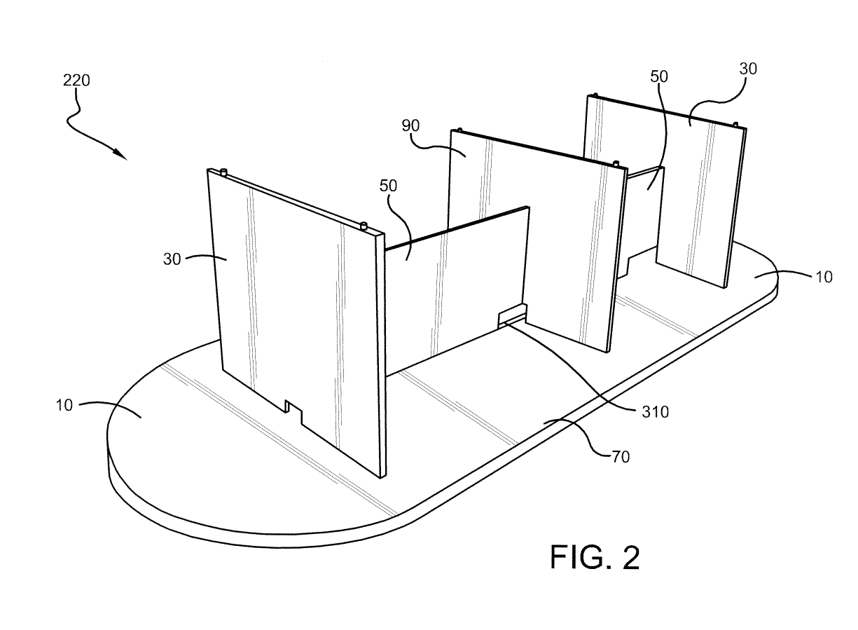

Referring now to the drawings wherein the showings are for purposes of illustrating embodiments of the invention only and not for purposes of limiting the same, and wherein like reference numerals are understood to refer to like components, FIG. 1 shows an assembled version of one embodiment, showing table 220, grommet 200, tabletop assembly 290, center support 90, modesty panel 58, and terminal support 30. More details are shown in FIG. 2, which shows the modular conference table 220, along with modular insert top 70 and underside 10 of end-tops 12, 14.

With reference now to FIGS. 1-15, the modular conference table 220 includes a tabletop assembly 290 including a first end-top 12, a second end-top 14, and a modular insert top 70. The modular insert top 70 includes at least one elongated central opening in which a grommet 200 is placed for accessing a utility port (not shown). The modular insert top 70 is interposed between the first and second end-tops 12, 14 to form a singular elongated work surface. Additionally, modular conference table 220 includes a leg assembly upholding the tabletop assembly 290. The leg assembly includes a first terminal support 32 perpendicularly attached to the first end-top 12, a second terminal support 34 perpendicularly attached to the second end-top 14 and a center support 90 interposed between the terminal supports 32, 34 and perpendicularly attached to the modular insert top 70. The modular insert top 70 also includes two modesty panels 50. The alpha modesty panel 52 is interposed between the first terminal support 32 and the center support 90. The beta modesty panel 54 is interposed between the second terminal support 34 and the center support 90. Additionally, each modesty panel 52, 54 is perpendicularly attached to the tabletop assembly 290. Additionally, a flat bracket 330 can be used to reinforce the connection of the end-tops 12, 14, and a power supply 340 can be added to the grommet 200, along with a wire trough 350, which is used to hide the wires 360.

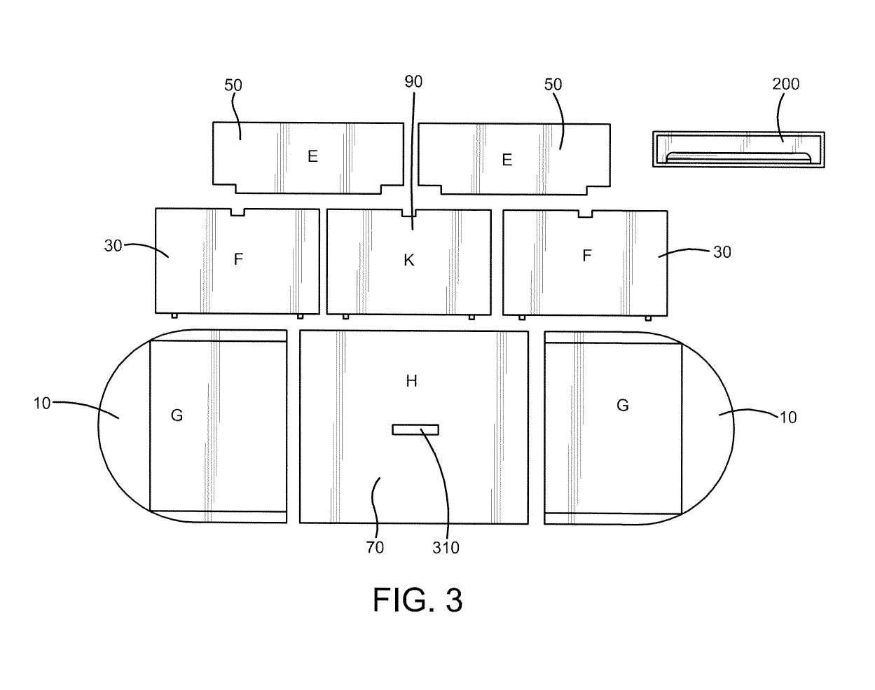

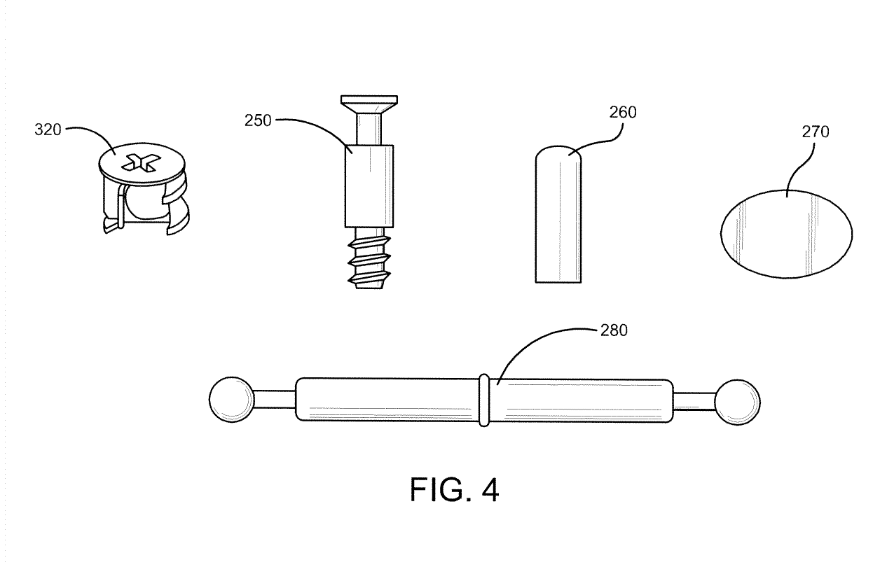

With reference now to FIG. 3, the table 220 is shown in an exploded view, showing the shape of the various components. FIG. 4 shows one embodiment of the hardware that can be used to assembly the table 220. FIG. 4 shows cam pin 250, dowel rod 260, cam cap 270, double cam pin 280, and cam lock 320. It is to be understood, however, that any means of connected the various pieces together can be used, as long as chosen using sound engineering judgment.

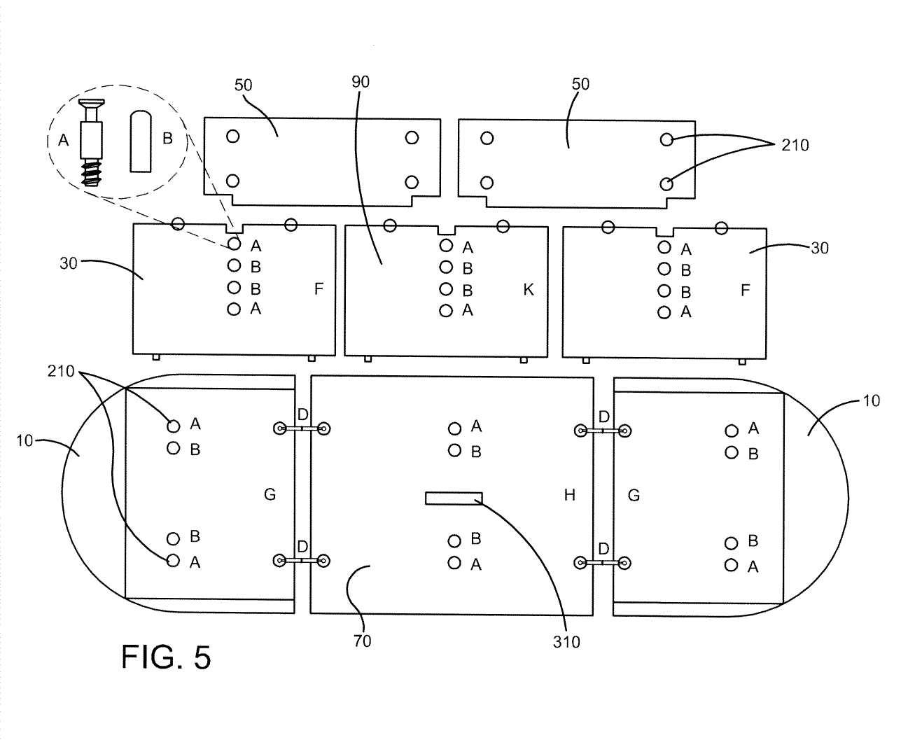

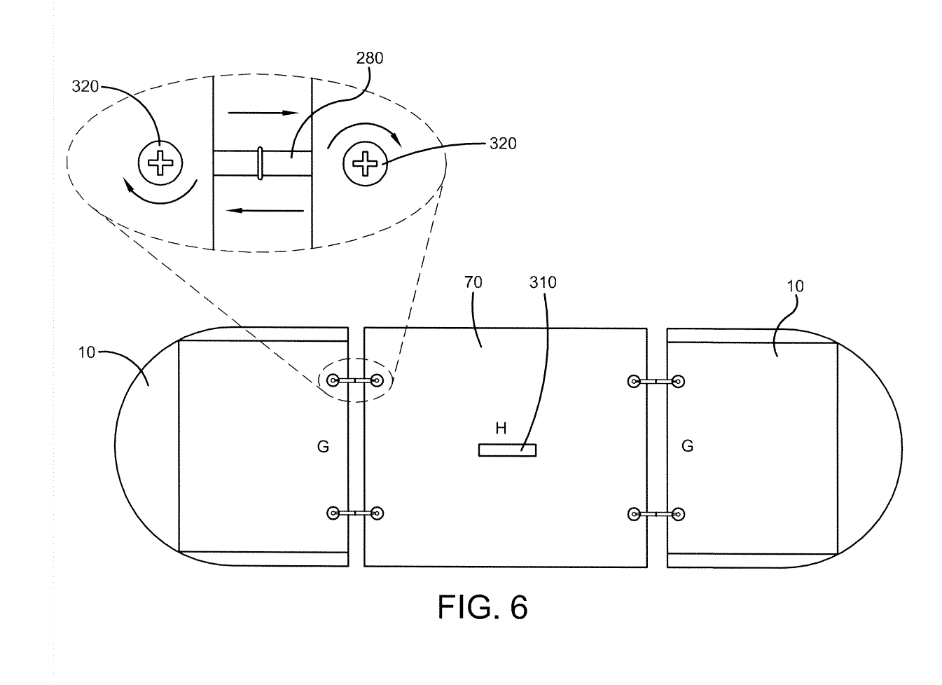

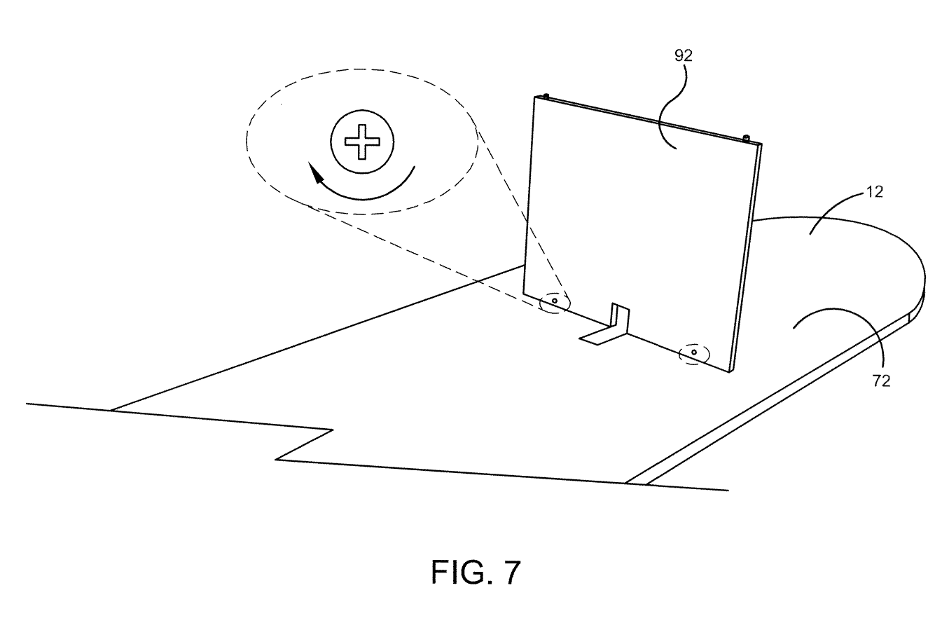

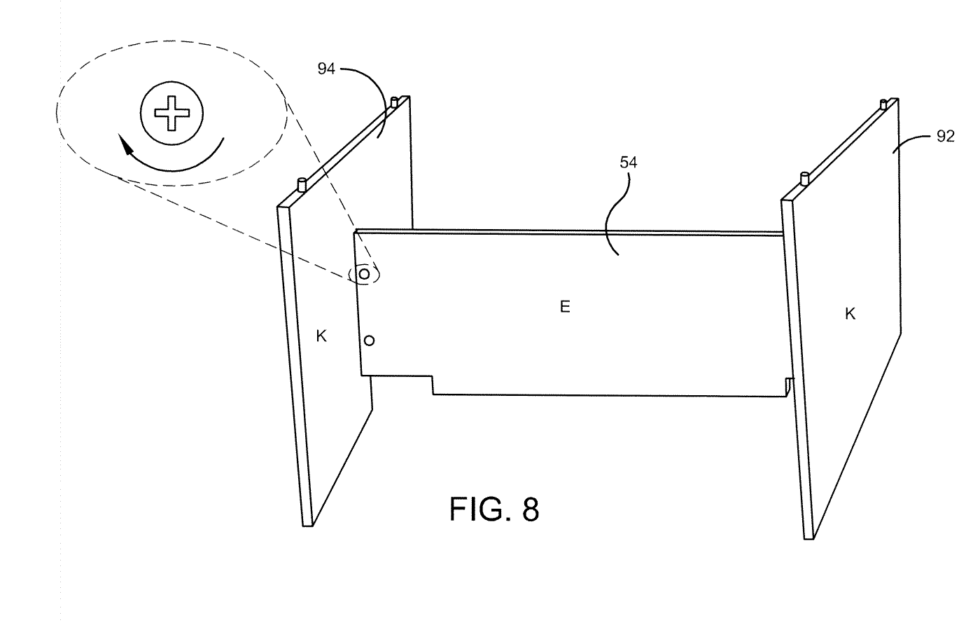

With reference now to FIGS. 6-10, the FIGURES show the attachment of the various parts, using the hardware shown in FIG. 3. FIG. 5 shows the attachment points for the modesty panels 50 and supports 30 to the underside 10 of the table 220. FIG. 6 shows and exploded view of one embodiment of the connection of the end tops 12, 14 to the insert top 70, using cam locks 320. FIG. 7 shows an exploded view of the connection of the center support 92 to the insert top 72 using cam lock 320. FIGS. 8-10 show the connection of the center supports 92, 94 to the modesty panel 54 using cam locks 320. It is to be understood, however, that any means of connected the various pieces together can be used, as long as chosen using sound engineering judgment.

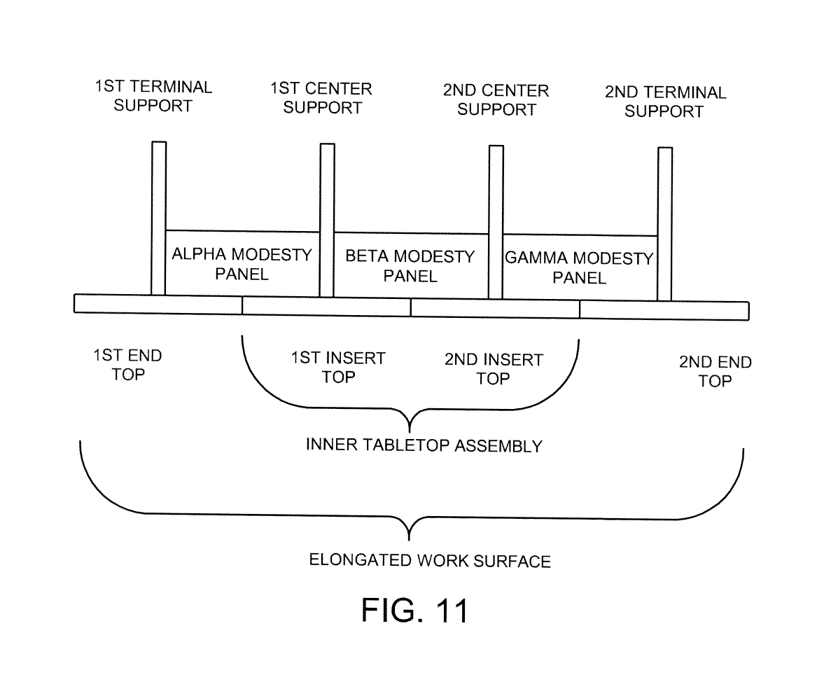

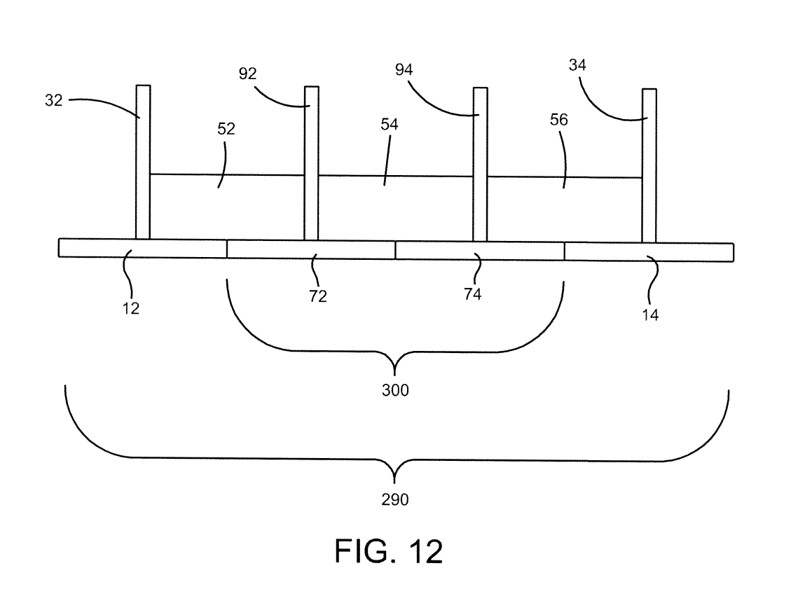

Referring now to FIGS. 11 and 12, which illustrate another embodiment, the modular conference table 220 includes a tabletop assembly 290, a leg assembly, and at least three modesty panels 52, 54, 56. The tabletop assembly 290 includes a first end-top 12, a second end-top 14 and at least two modular insert tops 72, 74. The modular insert tops 72, 74 are aligned with one another to form an inner tabletop assembly 300 where the inner tabletop assembly 300, formed by the two modular insert tops 72, 74, is interposed between the first and second end-tops 12, 14 to form an elongated work surface. The first and second end-tops 12, 14 are positioned at opposite ends of the inner tabletop assembly 300 such that the inner tabletop assembly 300 and the first and second end-tops 12, 14 are abutted end-to-end with each other and are aligned to form the elongated work surface 290. The leg assembly upholds the tabletop assembly. The leg assembly includes a first terminal support 32, a second terminal support 34, and at least two center supports 92, 94. The first terminal support 32 is perpendicularly attached to the first end-top 12. The second terminal support 34 is perpendicularly attached to the second end-top 14. The two center supports 92, 94 are interposed between the terminal supports 32, 34 and are perpendicularly attached to each modular insert top 72, 74. The modular conference table 220 also includes at least three modesty panels 52, 54, 56. Each modesty panel is perpendicularly attached to the elongated work surface 290.

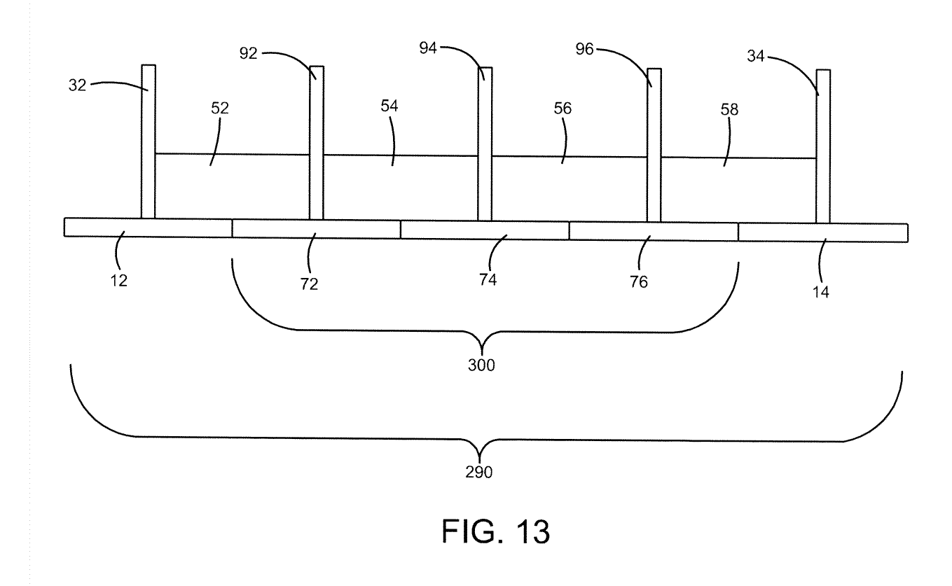

Referring now to FIG. 13 which illustrates yet another embodiment of this invention, the modular conference table 220 includes a tabletop assembly, a leg assembly, and at least four modesty panels 52, 54, 56, 58. The tabletop assembly includes a first end-top 12, a second end-top 14 and at least three modular insert tops 72, 74, 76. The modular insert tops 72, 74, 76 are aligned with one another to form an inner tabletop assembly 300 where the inner tabletop assembly 300 formed by the three modular insert tops 72, 74, 76 is interposed between the first and second end-tops 12, 14 to form an elongated work surface 290. The first and second end-tops 12, 14 are positioned at opposite ends of the inner tabletop assembly 300 such that the inner tabletop assembly 300 and the first and second end-tops 12, 14 are abutted end-to-end with each other and are aligned to form the elongated work surface 290. The leg assembly upholds the tabletop assembly. The leg assembly includes a first terminal support 32, a second terminal support 34, and at least three center supports 92, 94, 96. The first terminal support 32 is perpendicularly attached to the first end-top 12. The second terminal support 34 is perpendicularly attached to the second end-top 14. The three center supports 92, 94, 96 are interposed between the terminal supports 32, 34 and are perpendicularly attached to each modular insert top 72, 74, 76. The modular conference table 220 also includes at least four modesty panels 52, 54, 56, 58. Each modesty panel is perpendicularly attached to the elongated work surface 290.

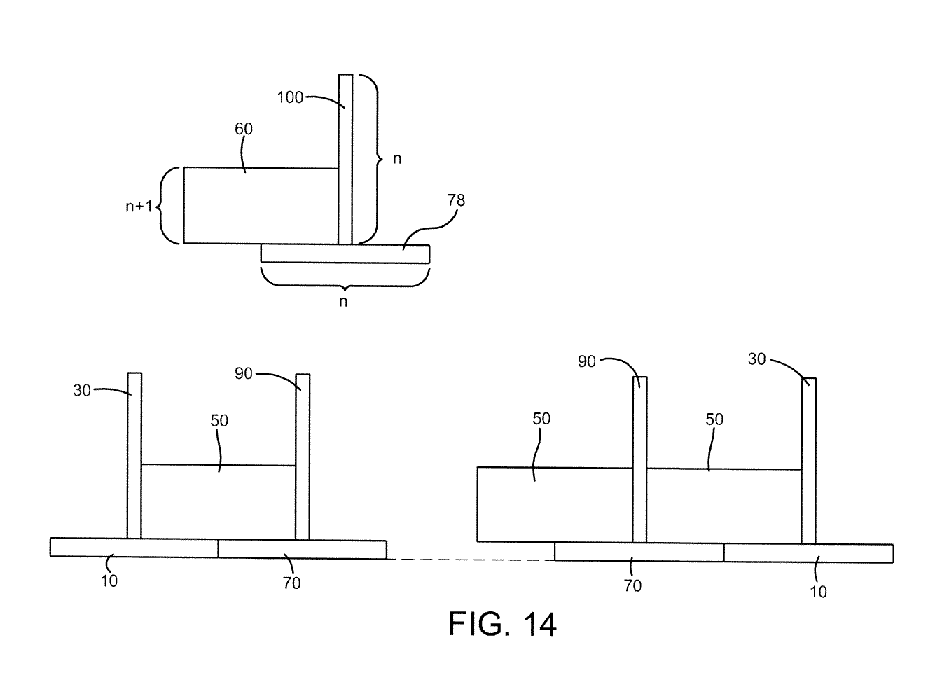

Referring now to FIG. 14 the present invention can be expanded in order to accommodate the needs of the user by adding an additional number of modular insert tops, modesty panels, and center supports. Thus, the invention described above can be expanded where the number n is equal to the number of modular insert tops and center supports desired and the number n+1 is the number of modesty panels needed. Upon reading and understanding this detailed specification, one of ordinary skill in the art could make the expansion of the current invention described above by adding the first, second, and third through the nth modular insert top 78, the first, second, and third through the nth center support 100, and the first, second, third, and fourth through the (n+1)th modesty panel 60.

According to yet another embodiment, a method may comprise the following steps. First, referring to FIGS. 4, 5, and 15, the cam pins 250, dowel rods 260, and double cam pins 280 are inserted into existing holes 210 in the first and the second terminal support 32, 34, the first and the second end-top 12, 14, the first and the second modular insert top 72, 74, and the alpha, beta, and gamma modesty panels 52, 54, 56. In another embodiment, a bracket 330 can be used on the bottom of the first and second end-tops 12, 14, towards the outer edges where the tops 12, 14 meet, to aid the double cam pins to join together the top sections 12, 14. Second, referring to FIGS. 6 and 12 the first and second modular insert tops 72, 74 are attached to one another such that each modular insert top is abutted end-to-end with the other and is aligned to form an inner tabletop assembly 300. Then the associated cam locks 320 are tightened. Next, the first and second end-tops 12, 14 are attached to opposite ends of the inner tabletop assembly 300 such that the inner tabletop assembly 300 and the first and second end-tops 12, 14 are abutted end-to-end with each other and are aligned to form an elongated work surface.

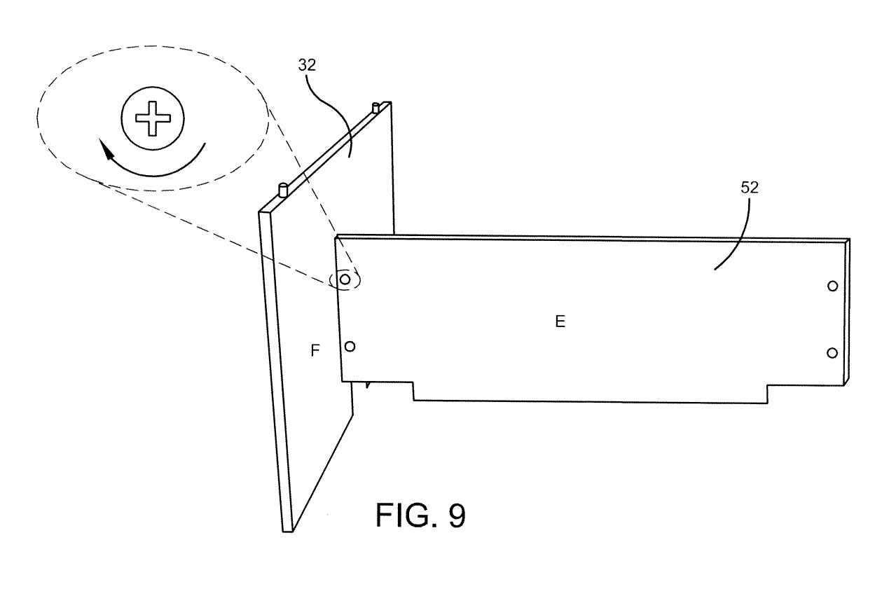

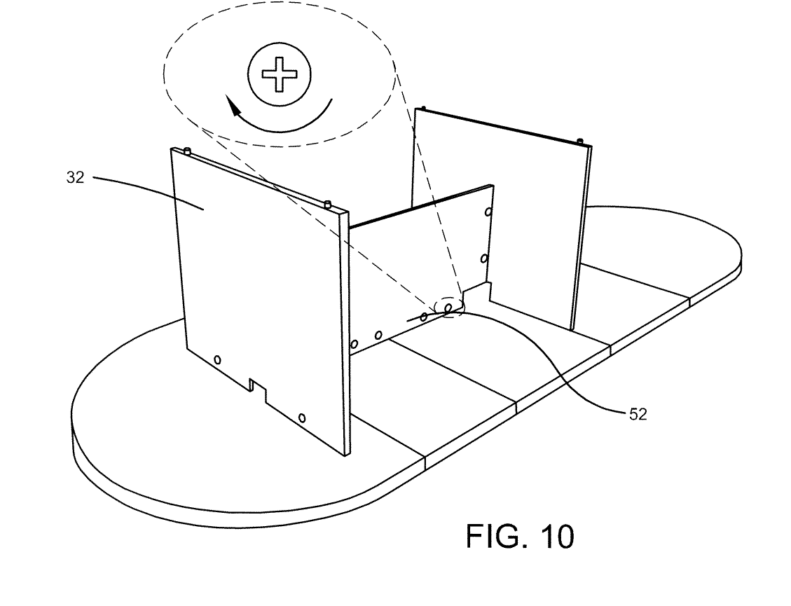

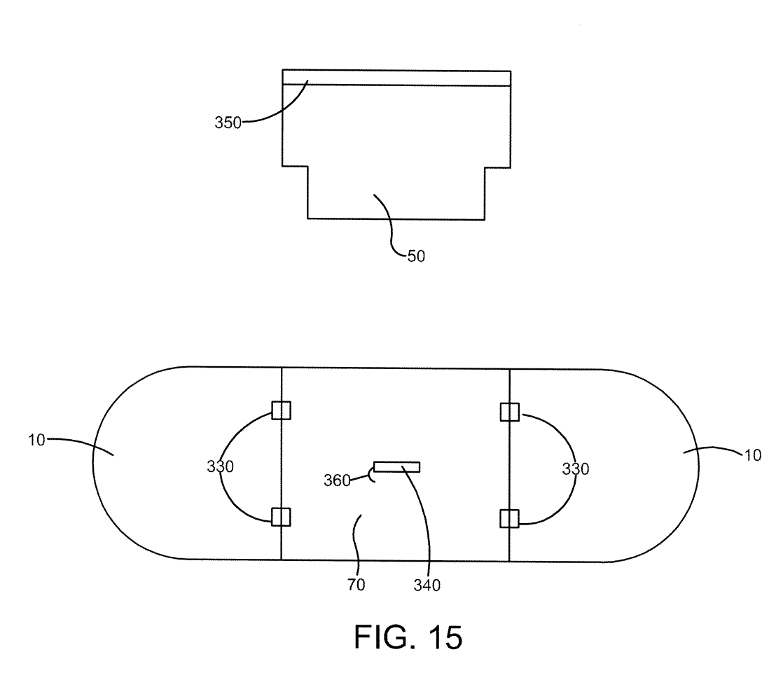

Referring to FIGS. 7 and 15, the first center support 92 is attached to the first modular insert top 72 and the associated cam locks 320 are tightened. Referring to FIG. 8, the alpha modesty panel 52 is attached to the first center support 92 and the first and second insert tops 72, 74 and the associated cam locks 320 are tightened. Then the second center support 94 is attached to the second insert top 74. Referring to FIG. 9, the gamma modesty panel 56 is attached to the second center support 94, the second insert top 74, the second end-top 14 and the associated cam locks 320 are tightened. Referring to FIG. 10, the second terminal support 34 is attached to the second end-top 14 and the associated cam locks 320 are tightened. Next, the alpha modesty panel 52 is attached to first center support 92, the first insert top 72, and the first end-top 12 and the associated cam locks 320 are tightened. Finally the first terminal support 32 is attached to the first end-top 12 and the associated cam locks 320 are tightened. Optionally, the cam locks 320 can be covered with cam caps 270. Additionally grommet 200 may be inserted into the elongated central opening 310. An optional power supply 350 can be provided to fit into the grommet 200. In this embodiment, at least one wire management trough 340 is attached to the top edge of the modesty panels 52 and is used to hide and manage wires 360 from the grommet 200 to the floor. It is to be understood that the various parts and there connectivity are not limited to the manner of connection in this paragraph. It is to be understood that any mechanism for connecting the supports, tops, and panels can be used, as long as chosen using sound engineering judgment.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof. Although the description above contains much specificity, this should not be construed as limiting the scope of the invention, but as merely providing illustrations of some of the presently preferred embodiments of this invention. Various other embodiments and ramifications are possible within its scope.

Furthermore, notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Having thus described the invention, it is now claimed:

fch I/We claim:

1. A table comprising:
a tabletop assembly including a first end-top, a second end-top, and a modular insert top which includes at least one elongated central opening in which a grommet is placed where the modular insert top is interposed between the first and second end-tops to form a singular elongated work surface;
a leg assembly upholding the tabletop assembly wherein the leg assembly includes a first terminal support perpendicularly attached to the first end-top, a second terminal support perpendicularly attached to the second end-top, and a center support located between the terminal supports and perpendicularly attached to the modular insert top: and,
two modesty panels, wherein the first modesty panel is interposed between the first terminal support and the center support, wherein the second modesty panel is interposed between the second terminal support and the center support, and wherein each modesty panel is perpendicularly attached to the elongated work surface.

2. A table comprising:
a substantially planar top surface, wherein the top surface includes two non-contiguous end portions;
at least one terminal support extending perpendicular from the two non-contiguous end portions; and,
at least one insertable top portion, wherein the insertable top portion is between the end portions, wherein the at least one insertable top portion has at least one terminal support extending perpendicularly from the top portion, wherein the at least one top portion and the two non-contiguous end portions for a substantially flat surface, wherein the at least one insertable top portion is removably attached to at least one of the end portions.

3. The table of claim 2, wherein the terminal supports are removably attached to the top portions.

4. The table of claim 3, wherein the table comprises at least two insertable top portions, wherein both top portions are between the end portions.

5. The table of claim 2, wherein the table further comprises:
at least one modesty panel, wherein the modesty panel extends downwardly from an underside of the top portion.

6. The table of claim 4, wherein the table further comprises:
at least two modesty panels, wherein the modesty panels extends downwardly from an underside of the top portion, wherein the modesty panels are removably attached to the terminal support of the top portion.

7. The table of claim 6, wherein the modesty panel is removably attached to the terminal support of the end portion.

8. The table of claim 2, wherein the table comprises:
n insertable top portions, wherein n>1, wherein the insertable top portions are between the end portions, wherein the insertable top portions have at least one terminal support extending perpendicularly from the top portion, wherein the top portions and the two non-contiguous end portions fora substantially flat surface, wherein the insertable top portions are removably attached to at least one of the end portions: and,
n+1 modesty panels, wherein the modesty panels extends downwardly from an underside of the top portion, wherein the modesty panels are removably attached to the terminal support of the top portion.

9. The table of claim 8, wherein the top portions, end portions, modesty panels, and terminal supports are connected to each other with cam pins and cam locks.

10. A method for increasing the size of a table, the method comprising the steps of:
inserting at least one top portion between two end portions;
connecting the at least one top portion to the end portions:
attaching a terminal support to the at least one top portion; and,
attaching a terminal support to each end portion, wherein the top portion and the terminal supports are removably attachable.

11. The method of claim 10, wherein the at least one top portion is at least two top portions.

12. The method of claim 10, wherein the method further comprises the steps of:
attaching a modesty panel on each side of the terminal support of the top portion; and,
attaching the modesty panels to terminal supports of the end portions.

13. The method of claim 11, wherein the method further comprises the steps of:
attaching a modesty panel on each side of the terminal supports of the top portions.

14. The method of claim 10, wherein the table comprises n insertable top portions, wherein n>1, wherein the insertable top portions are between the end portions, wherein the insertable top portions have at least one terminal support extending perpendicularly from the top portion, wherein the top portions and the two non-contiguous end portions for a substantially flat surface, wherein the insertable top portions are removably attached to at least one of the end portions; and,
n+1 modesty panels, wherein the modesty panels extends downwardly from an underside of the top portion, wherein the modesty panels are removably attached to the terminal support of the top portion.

15. The method of claim 14, wherein the top portions, end portions, modesty panels, and terminal supports are connected to each other with cam pins and cam locks.
